(19) United States
(12) Patent Application Publication
(10) Pub. No.: US 2007/0131009 A1
(43) Pub. Date: Jun. 14, 2007

(54) COATED SUBSTRATES COMPRISING ONE OR MORE MICROBES IN THE COATING AND METHODS OF USE

(75) Inventors: JASON WESTBROOK, Stephenville, TX (US); ALAN T. WARREN, The Woodlands, TX (US)

Correspondence Address: The Wendt Firm, P.C., 34 Driftoak Circle, The Woodlands, TX, 77381, US

(73) Assignee: Microbes,Inc., The Woodlands, TX (US)

(21) Appl. No.: 11/610,024

(22) Filed: Dec. 13, 2006

Related U.S. Application Data
(60) Provisional application No. 60/750,435, filed on Dec. 14, 2005.

(51) Int. Cl. C05F 11/08

(52) U.S. Cl. 71/6

(57) ABSTRACT

Compositions are described comprising a granular substrate, which may or may not be substantially devoid of microbes, and a coating on at least a portion of the granular substrate comprising a soluble component and a plurality of microbes dispersed in the soluble component. Methods of using the compositions in agricultural operations are also described. This abstract allows a searcher or other reader to quickly ascertain the subject matter of the disclosure. It will not be used to interpret or limit the scope or meaning of the claims.

### BACKGROUND OF THE INVENTION

1. Field of Invention

The invention is generally related to the field of formulation and use of fertilizer compositions for agricultural use. More specifically, the invention relates to fertilizer compositions that contain viable microbial bacteria in a coating on a granular or pill substrate.

2. Related Art

One of the principal goals of agricultural science has been to invent a perfect fertilizer composition that is capable of optimizing food plant production when used at minimum application rates and that, subsequently, will not degrade or adversely affect the soil ecosystem. The present invention attains this goal.

It is well understood that nitrogen (N), the single most important plant nutrient, has been over used in modern agriculture in an effort to encourage maximum plant yields. Nitrogen in the form of soluble nitrates is particularly harmful to the environment since nitrates readily leach out of soil and cause pollution of ground and surface waters.

Technology that permits lower use rates of N while maintaining plant yields is required worldwide. The present invention provides such technology by combining unique ingredients and processing them in such a way as to arrive at potentiated fertilizer compositions capable of effecting substantial benefits in plant production. The novelty of the present invention relates to specific synergisms between the various ingredients and to the processing technology that renders such ingredients functional.

Microorganisms have been utilized heretofore in various fertilizer preparations of the past; yet none of these have achieved substantial commercial success. This is because such prior art has not proven to be economically efficacious under real farming conditions. Technologies involving microbes have been plagued with inconsistencies due to the nature of these complex, organic substances.

Probiotic bacteria, are known, such as various strains of bacillus, as described in U.S. Pat. No. 6,878,179.

U.S. Pat. No. 6,228,806, Mehta, claims a biochemical fertilizer comprising A and B components, wherein A) a fertilizing effective quantity of a fertilizer for fertilizing soil which is either a) an essentially inorganic fertilizer, b) an organic fertilizer selected from the group consisting of blood meal, cottonseed meal, ocean kelp meal, and fish fertilizer, or c) a mixture of components a) and b); and B) a quantity of beneficial microorganisms in an amount of a least about 1×10⁵ microorganisms per gram of fertilizer sufficient to (a) further enhance plant growth when the fertilizer composition is applied to the soil; and/or b) control one or more pathogens in the soil; wherein component B) but not component A) is optionally encapsulated in a water-soluble coating and wherein component A) a) can contain up to about 50% by weight of organic nitrogen-containing compounds. A broad list of microorganisms, listed by genera, is disclosed, which is Bacillus. Mehta offers claims that specify the need to coat, or encapsulate, microorganisms with a water soluble coating, presumably for stability, but no mention is made of using coated substrates wherein the coating includes beneficial microorganisms. Specifically, when his fertilizer compositions are in solid form and component B) microorganisms are sensitive to light, air, or compounds in fertilizer component A) or to optional added components. Mehta teaches that the microorganisms can be separately encapsulated in water soluble coatings, e.g., dyed or undyed gelatin spheres or capsules, or by micro-encapsulation to a free flowing powder using one or more of gelatin, polyvinyl alcohol, ethylcellulose, cellulose acetate phthalate, or styrene maleic anhydride. The separately encapsulated microorganisms can then be mixed with the powder or larger particulates of component A) (which is not encapsulated) and any optional components. Encapsulation of the microorganisms preferably includes nutrients as well as the microorganisms.

U.S. Pat. No. 6,232,270, Branly, et al., focuses on using Bacillus bacteria to enhance the effectiveness of chemical herbicides and lists every imaginable Bacillus ever discovered, and claims they will all benefit this purpose. Unfortunately, the use of granular materials as a substrate, coated with a soluble coating comprising beneficial microorganisms is not disclosed or suggested.

U.S. Pat. No. 5,702,701, O'Donnell, claims the use of a unique strain of Bacillus laterosporus (BOD strain) to benefit plants. Tests showed that this strain is not the same as CM-3 strain of Bacillus laterosporus; for example, it does not adhere to plant roots and does not benefit actinomycetes and N-fixing bacteria in the rhizosphere. Nothing in the O'Donnell patent indicates how to compound B. laterosporus into a potentiated biofertilizer with the other active ingredients.

U.S. Pat. No. 6,174,472 describes a process of forming a pellet comprised of at least sixty percent composted sewer sludge, up to forty percent cellulosic plant material and up to fifteen percent nutrient materials and chemicals for soil enhancement and plant nutrition that provides a combination of both long and short term beneficiation of soil and herbage and has no pathogenic microbes above regulatory ranges. The composted sewer sludge comprises primary sewer sludge admixed with cellulosic plant material that is thermally treated at temperatures between 140 and 180 F. during composting to destroy mesophyllic pathogenic microbes and the viability of reproducible botanicals including seeds, but leave most thermophilic soil enhancing microbes in a viable state. Additional fibrous cellulosic material and chemicals are admixed with the composted sewer sludge and the mixture pelletized in a thermal process that raises pellet temperature to between 140 to 180 F. The nutrient and chemical materials selectively comprise nitrogenous fertilizers, phosphate, potash, trace elements, herbicides, insecticides and botanical chemicals. In the examples of the patent, three samples of composted primary sewer manure are presented, with the statement that “all of the heavy metal tests and bacterial assays were well within present regulatory standards of the Environmental Protection Agency required for use of the composted product as an agricultural soil enhancer.” However, the levels of cadmium, arsenic, and lead are high enough to be a concern, and these composted primary sewer samples are primarily useful only for ornamental plants and turf production, not food production.

U.S Pat. No. 6,025,187 describes bacterial complexes comprising at least one non-pathogenic Bacillus and at least one non-pathogenic Lactobacillus which essentially allow the conversion of inorganic nitrogen into organic nitrogen, in the form of bacterial proteins, which allow the conversion of excrement into nitrogenous compounds (stable nitrogenous compounds and/or compost) and, particularly for waste having a sufficient C/N ratio (in relation to the level of solids content), into non-polluting compounds rich in fulvic acid and humic acid, by digestion and conversion of excrements, while at the same time removing the associated pathogenic germs, in particular Clostridium, Bacteroides, colibacilli, Listeria, salmonellae and staphylococci. Unfortunately, the complexes disclosed in this patent require lactobacillus in addition to bacillus, and convert part of the excrement into humic acid, rather than adding humic acid from an external source, wherein the source and composition of the humic acid may be strictly controlled.

There is a great but heretofore unmet need worldwide for technology that permits lower use rates of N while maintaining plant yields. The present invention provides such technology.

### SUMMARY OF THE INVENTION

In accordance with the present invention, compositions and methods of use are described that reduce or overcome problems in previously known compositions and methods.

In accordance with the present invention, coated granular substrates that contain viable beneficial microorganisms, such as Bacillus bacteria, in a coating on a granular substrate are described. A first aspect of the invention is a coated granular substrate comprising:
(a) a granular substrate, which may or may not be substantially devoid of microbes; and
(b) a coating on at least a portion of the granular substrate comprising a soluble component and a plurality of beneficial microbes dispersed in the soluble component.

Another aspect of the invention are methods of using the coated granular substrates, one method comprising:
(a) supplying to a rhizosphere of a plant a sufficient amount of a coated granular substrate of the invention to increase yield without significantly increasing the nitrogen effect; and
(b) maintaining contact between the rhizosphere of the plant and the composition for a time sufficient to enhance yield of the plant while reducing nitrogen effect.

The various aspects of the invention will become more apparent upon review of the brief description of the drawings, the detailed description of the invention, and the claims that follow.

### DETAILED DESCRIPTION

In the following description. numerous details are set forth to provide an understanding of the present invention. However, it will be understood by those skilled in the art that the present invention may be practiced without these details and that numerous variations and modifications from the described embodiments may be possible.

All phrases, deviations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romanic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

As used herein the term “soluble” encompasses water-soluble, heat soluble, and combinations therof.

The term “granular” means a material that is able to be spread on crops, foliage, gardens, ornamentals, turf, and the like, without regard to shape. As an example, coated granular substrates of the invention may have any geometric shape, including prills, spheres, half-spheres, quarter spheres, cylinders, half cylinders, cones, half-cones, bells, half-bells, horns, quarter-horns, saddles, half-saddles, quarter-saddles and the like, although the majority of each coated granular substrate, and the majority of coated granular substrates as a whole in any collection, may be prill-shaped.

The terms “coated” and “coating” include single layers and multiple layers, and each coating layer may be uniform or non-uniform in composition, thickness, density, solubility and the like.

In the present invention, the phrase “dispersed in the soluble component” includes both uniform and non-uniform dispersions. The granular substrate may be selected from chemical N-P-K ingredients along with any other plant nutrient such as micronutrients, macronutrients, humates, and vitamins with Bacillus strains of microbes. Optionally, these formulations may also contain humic acid, N means nitrogenous or nitrogen-containing compounds (organic or inorganic), P indicates phosphorous-containing (organic or inorganic compounds), and K indicates potassium-containing (organic or inorganic compounds). The coating of the inventive coated granular substrates may comprise at least one species of probiotic Bacillus bacteria that exert a positive effect on the yield of agricultural plants and/or reduce the nitrogen requirements of agricultural plants. Optionally, the granular substrate may comprise one or more of N compounds, P compounds, K compounds, and combinations of two or more of these compounds (for example two N compounds, an N compound with a P compound, two K compounds, or one each of N compound, P compound, and K compound). Preferred compositions are those wherein the ingredients making up the substrate are blended into an admixture resulting in a granular product. Note that the granular substrate may also comprise one or more microbes in certain embodiments. Other preferred substrates are blended into an admixture resulting in a powdered product. Preferably, the ingredients are formed into hardened prills or pellets.

Coating of the substrate may be performed using any one or more coating processes. Many forms of plant nutrients are dry, granular materials that can be coated to control the release of ingredients having beneficial qualities for the rhizosphere. Coatings comprising microbes such as Bacillus would enhance the nutrient properties of each material by yield increase, disease defense and the reduction of nitrogen needed to produce high quality agricultural crops, landscape turf along with horticultural and ornamental plants. The Bacillus spores are able to stay stable in the coating until applied. Once applied the beneficial, non-genetically altered Bacillus spores would begin to multiply in the rhizosphere or root zone where they over-populate harmful bacteria to create a protected area around the roots by competitive exclusion. The result may be increased nutrient absorption by roots, defense against harmful pathogens, and reduction of the amount of plant nutrients applied. The coated granular substrates and processes of the invention may also allow much needed beneficial microbes to be added back to soil to create a healthy microbial balance in deficient soils. Any coating materials may be used as long as it dissolves under heat, water, or combination, and perhaps pH less than 5 and more than 9; the microbes and coating matrix material are compatible for at least the time measured from making the coated product up to its use; and the coating functions as a binder for binding the microbes to the underlying substrate particle.

The Bacillus spores may be from strains of probiotic Bacillus bacteria capable of enhancing beneficial microbial populations within the rhizosphere.

Humic acid, if used, may be derived from lignite. As used herein, “humic acid” means a polymeric compound typically containing the brownish-black pigment melanin, and can be obtained from lignite. It is soluble in bases, but insoluble in mineral acids and alcohols. It is not a well-defined compound, but a mixture of polymers containing aromatic and heterocyclic strictures, carboxyl groups, and nitrogen, and is used in drilling fluids, printing inks, and plant growth. See Hawley's Condensed Chemical Dictionary, 12. sup.th Edition, (1993), page 608. Not all humic acids behave in a similar fashion.

Coated granular substrates of the invention include those wherein the N compounds are selected from the group consisting of urea, ammonium sulfate, ammonium nitrate, ammonium phosphate, calcium nitrate, potassium nitrate, sodium nitrate; the P compounds are selected from the group consisting of ammonium phosphate, superphosphate, Ca(H₂PO4)₂, tricalcium phosphate, phosphate salts of sodium or potassium, including orthophosphate salts; and the K compounds are selected from the group consisting of KCl, potassium sulfate, potassium nitrate, and phosphate salts of potassium, including orthophosphate salts.

Substrates useful in the invention include organic fertilizers, inorganic fertilizers (including fertilizer “seeds” , where seed refers to the chemical particle from which the fertilizer granule derives from, in other words the particle of chemical which becomes larger as chemicals combine together through a tumbling motion), and combinations thereof. Coated granular substrates in accordance with the invention include those wherein the substrate comprises one or more of nitrogenous fertilizers, phosphate, potash, trace elements, herbicides, insecticides and botanical chemicals.

Substrates useful in coated granular substrates of the invention may assume homogenous and heterogeneous forms. Heterogeneous forms include structures where one part of the structure has a certain chemical composition, while another part of the structure has a different chemical composition. An example may be a coated granular substrate having two or more chemically distinct compositions or phases in different regions of the substrate. Heterogeneous substrate forms may include different substrates joined together by a binder, for example where more then one of the above listed forms are joined into a larger irregular structure. Moreover, all substrates may have cracks, dislocations, branches or other imperfections.

The coating may be organic, inorganic, or combination thereof. Suitable organic coatings include water-soluble polymeric coatings. The coating functions to hold the microbes in the coating and dissolve when exposed to users defined conditions in a user controlled fashion, i.e., at a rate and location controlled by the structural, physical, and chemical make-up of the coating. The coating may comprise a water-soluble inorganic material, a water-soluble organic material, and combinations thereof. The water-soluble organic material may comprise a water-soluble natural or synthetic polymeric material, for example, but not limited to gelatins, ethylcellulose, cellulose acetate phthalate, styrene maleic anhydride poly(vinyl alcohol), poly(lactic acid), and the like. The water-soluble polymeric material may either be a normally water-insoluble polymer that is made soluble by hydrolysis of side chains, or the main polymeric chain may be hydrolyzable. Blends of natural and synthetic polymers, and layered versions of polymers, wherein individual layers may be the same or different in composition and thickness, may be used effectively. The term “coating” is not meant to exclude any particular form or morphology and is used merely as a term of convenience in describing the coated granular substrate of the invention. The term includes composite polymeric materials, such as, but not limited to, polymeric materials having fillers, plasticizers, and fibers therein other than substrates.

The coatings of the present invention include those wherein the microbes are prepared in water suspension and then added to the ingredients making up the coating. The compositions of the invention preferably have microbial spores present in sufficient concentrations to effect a viable spore count of between 10⁶ cfu to 10⁹ cfu per gram of dry composition.

Microbes useful in the invention include any genera or family of microbes that will be beneficial in reducing nitrogen requirement and cause and increase in beneficial microbes in the rhizosphere of a plant. Examples include genera Bacillus, Clostridium, Rhodopseudomonas, Pseudomonas, Arthrobacter, Flavobacteria, Saccharomyces, Azotobacter, Trichoderma, Penicillum, and Alternaria.

While not being limited to Bacillus, it is known that certain probiotic Bacillus species cause an increase in numbers of unrelated, yet beneficial, microbial species within the rhizosphere and, concomitantly, cause significant yield increases and/or nitrogen sparing effects. Thus another aspect of the invention is a method of increasing concentration of beneficial non-bacillus organisms in a rhizosphere, the method comprising applying an effective amount of a composition of the invention to a rhizosphere for a time sufficient to increase concentration of non-bacillus beneficial organisms in the rhizosphere, the non-bacillus beneficial organisms selected from the group consisting of actinomycetes and nitrogen fixing bacteria.

Several Bacillus spores useful in the invention have been deposited at the American Type Culture Collection (“ATCC”), 10801 University Blvd., Manassas, Va. 20110-2209, under accession numbers indicated herein. Strains of B. subtilus and B. lichenformis were deposited Aug. 27, 2004, while strains of B. laterosporous were deposited prior to Aug. 27, 2004. Bacillus spores, if used, may originate from Bacillus selected from the group consisting of Bacillus laterosporous (ATCC PTA-3952), Bacillus laterosporus (ATCC PTA-3593), Bacillus lichenformis (ATCC PTA 6175), Bacillus subtilus (ATCC PTA-6174), and mixtures thereof. The microbes may be mixtures of two or more microbes, such as two or more of Bacillus laterosporus (ATCC PTA-3952), Bacillus laterosporous (ATCC PTA-3593), Bacillus lichenformis (ATCC PTA 6175), and Bacillus subtilus (ATCC PTA-6174).

Coated granular substrates within the invention include those wherein the substrate may be selected from natural fertilizers, synthetic fertilizers, and combinations thereof.

Optionally, if the coated granular substrates are desired to be in the form of prills or pellets, humic acid may be added as a hardening agent. The humic acid may be selected from the group consisting of leonardite and potassium humate. The hypochlorite compound is preferably selected from the group consisting of either calcium hypochlorite, sodium hypochlorite, and mixtures thereof. The hypochlorite compound is preferably added at about 0.5. to about 3.0 percent by weight.

Polymeric coating materials useful in the invention must dissolved under moderate environmental heat, water, or combination thereof according to the local weather patterns expected during use, and perhaps pH less than 5 and more than 9. The microbes and coating matrix material should be compatible for at least the time measured from making the coated product up to its use. The coating functions as a binder for binding the microbes to the underlying substrate particle. Polymeric coating materials useful in the invention may be selected from natural and synthetic polymers, blends of natural and synthetic polymers and layered versions of polymers, wherein individual layers may be the same or different in composition and thickness. The term “polymeric coating” includes composite polymeric materials, such as, but not limited to, polymeric materials having fillers, plasticizers, and fibers therein.

Although only a few exemplary embodiments of this invention have been descried in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, no clauses are intended to be in the means-plus-function format allowed by 35 U.S.C. § 112, paragraph 6 unless “means for” is explicitly recited together with an associated function. “Means for” clauses are intended to cover the structures described herein as performing the recited function and not only structural equivalents, but also equivalent structures.

What is claimed is:

1. An coated granular substrate comprising:
(a) a granulate substrate, which may or may not be substantially devoid of microbes; and
(b) a coating on a least a portion of the granular substrate comprising a soluble component and a plurality of microbes dispersed in the soluble component.

2. The coated granular substrate of claim 1 wherein the granular substrate is selected from chemical N-P-K ingredients, plant nutrients, humates, and vitamins.

3. The coated granular substrate of claim 2 wherein the plant nutrients are selected from micronutrients and macronutrients.

4. The coated granular substrate of claim 1 wherein the soluble component is soluble component is water-soluble, heat-soluble, or combination thereof.

5. The coated granular substrate of claim 4 wherein the water-soluble component is selected from water-soluble inorganic materials, water-soluble organic materials, and combinations thereof.

6. The coated granular substrate of claim 5 wherein the water soluble organic material is a water-soluble polymeric material selected from gelatins, ethylcellulose, cellulose acetate phthalate, styrene maleic anhydride, poly(vinyl alcohol), poly(lactic acid), and the like.

7. The coated granular substrate of claim 6 wherein the water-soluble polymeric material is selected from a normally water-insoluble polymer that is made soluble by hydrolysis of side chains, or the main polymeric chain is hydrolyzable.

8. The coated granular substrate of claim 1 wherein the plurality of microbes is selected from genera Bacillus, Clostridium, Rhodopseudomonas, Pseudomonas, Arthrobacter, Flavobacteria, Saccharomyces, Azotobacter, Trichoderma, Penicillium, and Alternaria.

9. The coated granular substrate of claim 8 wherein the microbes are bacillus microbes selected from strains of B. subtilus, B. lichenformis, B. laterosporous, and mixtures thereof.

10. The coated granular substrate of claim 9 wherein the Bacillus spores are derived from Bacillus selected from Bacillus laterosporous (ATCC PTA-3952), Bacillus laterosporous (ATCC PTA-3593), Bacillus lichenformis (ATCC PTA-6175), Bacillus subtilus (ATCC PTA-6174), and mixtures thereof.

11. The coated granular substrate of claim 10 where the the Bacillus spores are derived from mixtures of two or more of Bacillus laterosporous (ATCC PTA-3952), Bacillus laterosporous (ATCC PTA-3593), Bacillus lichenformis (ATCC PTA-6175), and Bacillus subtilus (ATCC PTA-6174).

12. The coated granular substrate of claim 10 wherein the Bacillus spores are derived from Bacillus laterosporous (ATCC PTA-3952).

13. The coated granular substrate of claim 10 wherein the Bacillus spores are derived from Bacillus laterosporous (ATCC PTA-3953).

14. The coated granular substrate of claim 10 wherein the Bacillus spores are derived from Bacillus lichenformis (ATCC PTA-6175).

15. The coated granular substrate of claim 10 wherein the Bacillus spores are derived from Bacillus subtilus (ATCC PTA-6174).

16. The coated granular substrate of claim 2 wherein the N compounds are selected from the group consisting of urea, ammonium sulfate, ammonium nitrate, ammonium phosphate, calcium nitrate, potassium nitrate, sodium nitrate; the P compounds are selected from the group consisting of ammonium phosphate, superphosphate, Ca(H₂PO4)₂, tricalcium phosphate, phosphate salts of sodium or potassium, including orthophosphate salts; and the K compounds are selected from the group consisting of KCl, potassium sulfate, potassium nitrate, and phosphate salts of potassium, including orthophosphate salts.

17. A method comprising:
(a) supplying to a rhizosphere of a plant a sufficient amount of a composition comprising a coated granular substrate to increase yield without significantly increasing the nitrogen effect, the coated granular substrate comprising a granular substrate, which may or may not be substantially devoid of microbes, and a coating on at least a portion of the granular substrate comprising a soluble component and a plurality of microbes dispersed in the soluble component; and
(b) maintaining contact between the rhizosphere of the plant and the composition for a time sufficient to enhance yield of the plant while reducing nitrogen effect.

18. The method of claim 17 wherein the microbes are Bacillus microbes.

19. The method of claim 18 wherein the Bacillus microbes are selected from Bacillus laterosporous (ATCC PTA-3952), Bacillus laterosporous (ATCC PTA-3593), Bacillus lichenformis (ATCC PTA-6175), Bacillus subtilus (ATCC PTA-6174), and mixtures therof.

20. A method of increasing concentration of beneficial non-bacillus organisms in a rhizosphere, the method comprising applying an effective amount of a coated granular substrate to a rhizosphere for a time sufficient to increase concentration of non-bacillus beneficial organisms in the rhizosphere, the non-bacillus beneficial organisms selected from the group consisting of actinomycetes and nitrogen fixing bacteria, the coated granular substrate comprising a granular substrate, which may or may not be substantially devoid of microbes; and a coating on at least a portion of the granular substrate comprising a soluble component and a plurality of microbes dispersed in the soluble component.
